(19) United States
(12) Patent Application Publication
(10) Pub. No.: US 2012/0272543 A1
(43) Pub. Date: Nov. 1, 2012

(54) HEAT REFLUX DRYING MACHINE UTILIZING INLET/OUTLET AIR TEMPERATURE DIFFERENCE TO CONDENSE WATER

(76) Inventor: Tai-Her YANG, Dzan-Hwa (TW)

(21) Appl. No.: 13/097,195

(22) Filed: Apr. 29, 2011

(51) Int. Cl. F26B 21/00

(52) U.S. Cl. 34/73

(57) ABSTRACT

The present invention utilizes hot air containing water discharged from a heating space to pass through a top/down bended fluid pipeline (1035) formed by an external part of housing (1030) of a pipeline segment having water condensing function (1029) and a top/down bended flow guiding structure (1032), meanwhile external inlet air having relatively low temperature passing through an internal part of housing (1031) of the pipeline segment having water condensing function (1029) is pumped in to enable the hot air containing water to be cooled, thereby the contained water is condensed and thereby is collected or flows with a part of the hot air to pass through an hot air shunt port (1026) for being guided to be discharged from an external discharging port (109); and a part of the hot air is guided by the hot air shunt port (1026) to flow towards a returned hot air inlet (1022), thereby reducing the thermal energy loss and saving electric energy.

### BACKGROUND OF THE INVENTION

(a) Field of the Invention

The present invention relates to a heat reflux drying machine utilizing inlet/outlet air temperature difference to condense water, in which hot air containing water discharged from a heating space passes through a hot air pumping inlet (111) for being pumped by an electric fluid pump (106), the pumped hot air passes through a top/down bended fluid pipeline (1035) formed by an external part of housing (1030) of a pipeline segment having water condensing function (1029) and a top/down bended flow guiding structure (1032), meanwhile external inlet air having relatively low temperature passing through an internal part of housing (1031) of the pipeline segment having water condensing function (1029) is pumped in, the temperature difference between the above two enables the hot air containing water to be cooled, thereby the contained water is condensed, the condensed water is collected or flows with a part of the hot air to pass through an hot air shunt port (1026) for being guided to be discharged from an external discharging port (109); and a part of the hot air passing through the top/down bended fluid pipeline (1035) formed by the external part of housing (1030) of the pipeline segment having water condensing function (1029) and the top/down bended flow guiding structure (1032) is guided by the hot air shunt port (1026) to flow towards a returned hot air inlet (1022) for entering a clod/hot air mixing space structure (1023), for being preheated and mixed with the external air then entering a fluid heating device (103) for the subsequent heating, thereby reducing the thermal energy loss and saving electric energy.

(b) Description of the Prior Art

A conventional rolling-type drying device, e.g. a drying equipment, drum-type cloth drying machine, heating type dehumidifier or hand drying machine, often utilizes an electric fluid pump to pump the external air to pass through an electric heating device for being heated then entering a heating space for drying the articles to be dried, then the hot air is discharged to the exterior; during the operation, the hot air is not dehumidified and returned to the fluid heating device, and does not perform heat exchange with the external air for the purpose of heat recycling, thereby thermal energy and electric energy being wasted.

### SUMMARY OF THE INVENTION

The present invention provides various kinds of drying machines, wherein an electric fluid pump being installed for pumping external air having relatively low temperature into a fluid heating device for being heated then entering a heating space for drying the articles to be dried, and further installed with an inlet/outlet temperature difference water condensing and heat refluxing device (102), wherein the external air having relatively low temperature is pumped by the electric fluid pump (106) for entering an internal part of housing (1031) of a pipeline segment having water condensing function (1029), then entering a cold/hot air mixing space structure (1023) from an air intake port (1021), meanwhile the hot air containing water discharged from the heating space passes through the hot air pumping inlet (111) then be pumped by the electric fluid pump (106) for passing through a top/down bended fluid pipeline (1035) formed by an external part of housing (1030) of the pipeline segment having water condensing function (1029) and a top/down bended flow guiding structure (1032), then a part of the hot air passes through a hot air shunt port (1026) and a fluid guiding surface (1020) for entering the cold/hot air mixing space structure (1023) for being preheated and mixed with the pumped-in external air having relatively low temperature then entering a fluid heating device (103) for the subsequent heating, thereby reducing theiinal energy loss and saving electric energy. With the hot air shunt port (1026), a part of the hot air is discharged from an external discharging port (109), meanwhile the thermal energy of the hot air passing through the top/down bended fluid pipeline (1035) formed by the external part of housing (1030) of the pipeline segment having water condensing function (1029) and the top/down bended flow guiding structure (1032) is utilized to preheat the external air having relative low temperature passing through the internal part of housing (1031) of the pipeline segment having water condensing function (1029), thus the temperature difference of the above two enables the water contained in the hot air to be condensed in the external part of housing (1030) of the pipeline segment having water condensing function (1029) of the inlet/outlet temperature difference water condensing and heat refluxing device (102) for being collected or discharged to the exterior.

### BRIEF DESCRIPTION OF THE DRAWINGS

FIG. 1 a schematic view showing the main structure of the present invention.

FIG. 2 is a cross view of FIG. 1 taken along an A-A line.

FIG. 3 is a schematic structural view showing the present invention being applied in a drum type cloth drying machine, according to one embodiment of the present invention.

FIG. 4 is a schematic structural view showing the present invention being applied in a dehumidifier, according to one embodiment of the present invention.

FIG. 5. is a schematic structural view showing a static flow unifying structure (1027) being installed at the outlet of the cold/hot air mixing space structure (1023), according to one embodiment of the present invention.

FIG. 6 is a schematic structural view showing a free rotation stir blade structure (1028) being installed at the outlet of the cold/hot air mixing space structure (1023), according to one embodiment of the present invention.

FIG. 7 is a schematic structural view showing the pipeline segment having water condensing function (1029) of the inlet/outlet temperature difference water condensing and heat refluxing device (102) being installed with the thermoelectric cooling chip (200), according to one embodiment of the present invention.

FIG. 8 is a schematic structural view showing the pipeline segment having water condensing function (1029) of the inlet/outlet temperature difference water condensing and heat refluxing device (102) being installed with the thermoelectric cooling chip (200) for replacing the fluid heating device (103), according to one embodiment of the present invention.

FIG. 9 is a cross view showing the internal and external parts of the pipeline segment having water condensing function (1029) being formed in fin-like shapes, according to one embodiment of the present invention.

FIG. 10 is a cross view showing the internal and external parts of the pipeline segment having water condensing function (1029) being installed with the thermoelectric cooling chip (200), according to one embodiment of the present invention.

### DESCRIPTION OF MAIN COMPONENT SYMBOLS

101: Air inlet

102: Inlet/outlet temperature difference water condensing and heat refluxing device

103: Fluid heating device

104: Heating space

105: Drum driving motor set

106: Electric fluid pump

107: Electronic control device

108: External operation interface

109: External discharging port

110: Air intake flowpath

111: Hot airflow pumping inlet

200: Electrically-charged refrigeration chip

1020: Fluid guiding surface

1021: Air intake port

1022: Returned hot airflow inlet

1023: Cold/hot airflow mixing space structure

1026: Hot airflow shunt orifice

1027: Static flow unifying structure

1028: Free rotation stir blade structure

1029: Pipeline segment having water condensing function

1030: External housing part of pipeline segment having water condensing function (1029)

1031: Internal housing part of pipeline segment having water condensing function (1029)

1032: Top/down bended flow guiding structure

1035: Top/down bended fluid pipeline

1040: Drum device

1061: Fluid pumping motor

1062: Fluid pump

### DETAILED DESCRIPTION OF THE PREFERRED EMBODIMENTS

A conventional drum-type drying device, e.g. a drying equipment, drum-type cloth drying machine, heating type dehumidifier or hand drying machine, often utilizes an electric fluid pump to pump the external air to pass through an electric heating device for being heated then entering a heating space for drying the articles to be dried, then the hot air is discharged to the exterior; during the operation, the hot air is not dehumidified and returned to the fluid heating device, and does not perform heat exchange with the external air for the purpose of heat recycling, thereby thermal energy and electric energy being wasted.

The present invention relates to a heat reflux drying machine utilizing inlet/outlet air temperature difference to condense water, in which hot air containing water discharged from a heating space passes through a hot air pumping inlet (111) for being pumped by an electric fluid pump (106), the pumped hot air passes through a top/down bended fluid pipeline (1035) formed by an external part of housing (1030) of a pipeline segment having water condensing function (1029) and a top/down bended flow guiding structure (1032), meanwhile external air having relatively low temperature passing through an internal part of housing (1031) of the pipeline segment having water condensing function (1029) is pumped in, the temperature difference between the above two enables the hot air containing water to be cooled, thereby the contained water is condensed, the condensed water is collected or flows with a part of the hot air to pass through an hot air shunt port (1026) for being guided to be discharged from an external discharging port (109); and a part of the hot air passing through the top/down bended fluid pipeline (1035) formed by the external part of housing (1030) of the pipeline segment having water condensing function (1029) and the top/down bended flow guiding structure (1032) is guided by the hot air shunt port (1026) to flow towards a returned hot air inlet (1022) for entering a clod/hot air mixing space structure (1023), for being preheated and mixed with the external air then entering a fluid heating device (103) for the subsequent heating, thereby reducing the thermal energy loss and saving electric energy.

The present invention provides various kinds of drying machines, wherein an electric fluid pump being installed for pumping external air having relatively low temperature into a fluid heating device for being heated then entering a heating space for drying the articles to be dried, and further installed with an inlet/outlet temperature difference water condensing and heat refluxing device (102), wherein the external air having relatively low temperature is pumped by the electric fluid pump (106) for entering an internal part of housing (1031) of a pipeline segment having water condensing function (1029), then entering a cold/hot air mixing space structure (1023) from an air intake port (1021), meanwhile the hot air containing water discharged from the heating space passes through the hot air pumping inlet (111) then be pumped by the electric fluid pump (106) for passing through a top/down bended fluid pipeline (1035) formed by an external part of housing (1030) of the pipeline segment having water condensing function (1029) and a top/down bended flow guiding structure (1032), then a part of the hot air passes through a hot air shunt port (1026) and a fluid guiding surface (1020) for entering the cold/hot air mixing space structure (1023) for being preheated and mixed with the pumped-in external air having relatively low temperature then entering a fluid heating device (103) for the subsequent heating, thereby reducing thermal energy loss and saving electric energy. With the hot air shunt port (1026), a part of the hot air is discharged from an external discharging port (109), meanwhile the thermal energy of the hot air passing through the top/down bended fluid pipeline (1035) formed by the external part of housing (1030) of the pipeline segment having water condensing function (1029) and the top/down bended flow guiding structure (1032) is utilized to preheat the external air having relative low temperature passing through the internal part of housing (1031) of the pipeline segment having water condensing function (1029), thus the temperature difference of the above two enables the water contained in the hot air to be condensed in the external part of housing (1030) of the pipeline segment having water condensing function (1029) of the inlet/outlet temperature difference water condensing and heat refluxing device (102) for being collected or discharged to the exterior.

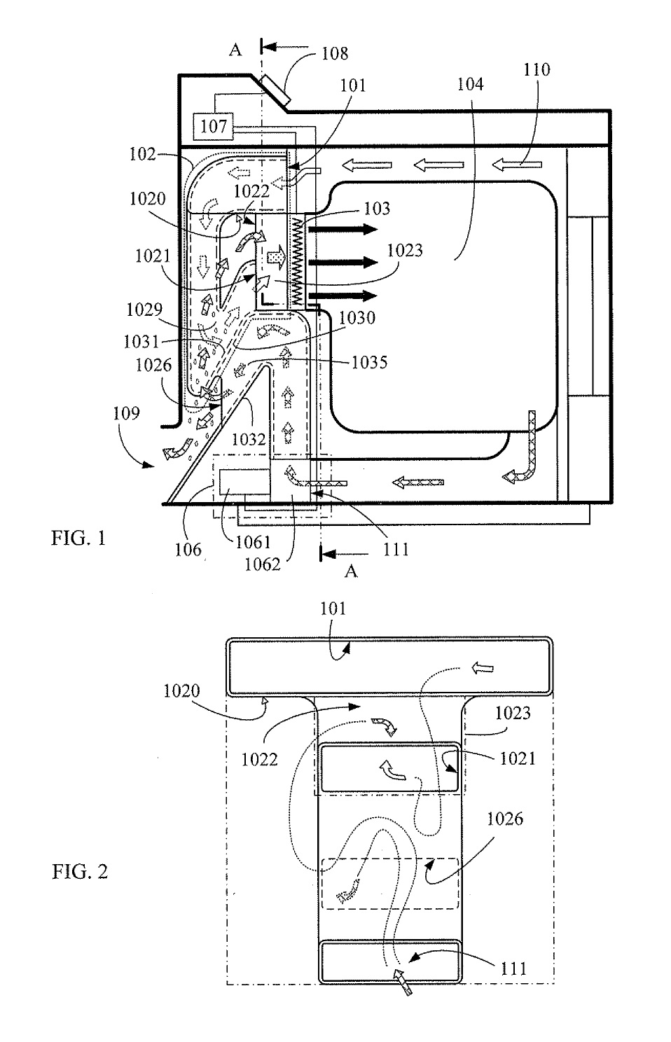

FIG. 1 a schematic view showing the main structure of the present invention;

FIG. 2 is a cross view of FIG. 1 taken along an A-A line.

As shown in FIG. 1 and FIG. 2, beside the housing and the electric conductive wires, it mainly consists of:
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering a heating space (104);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);

and having an top/down bended fluid pipeline (1035) formed by the external part of housing (1030) of the pipeline segment having water condensing function (1029) and an top/down bended flow guiding structure (1032) which allows the hot air discharged from the heating space (104) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);

The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the heating space (104) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;

through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing into the heating space (104);
Heating space (104): having a hot air inlet and outlet, formed with an internal space for accommodating the articles to be dried, wherein the heating space can be a sealed space, semi-opened space or opened space; the hot air inlet of the heating space (104) allows the hot air from the fluid heating device (103) to flow in, and the hot air outlet of the heating space (104) is provided for discharging the hot air which is leaded to the hot air pumping inlet (111);
Electric fluid pump (106): installed between the heating space (104) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the heating space (104) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the heating space (104) after being re-heated by the fluid heating device (103);

A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);

When being operated, the electronic control device (107) actuates the electric fluid pump (106) and the fluid heating device (103), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), then flows through the fluid heating device (103) for being heated then entering the heating space (104), and the hot air containing water discharged from the heating space (104) passes through the hot air pumping inlet (111), then is pumped by the electric fluid pump (106) to flow through the top/down bended fluid pipeline (1035);

The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior;

through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);

With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103), and when the hot air discharged from the heating space (104) passes through the top/down bended fluid pipeline (1035), the thermal energy of the hot air is utilized to preheat the external air having relatively low temperature and passing through the internal part of housing (1031) of the pipeline segment having water condensing function (1029);

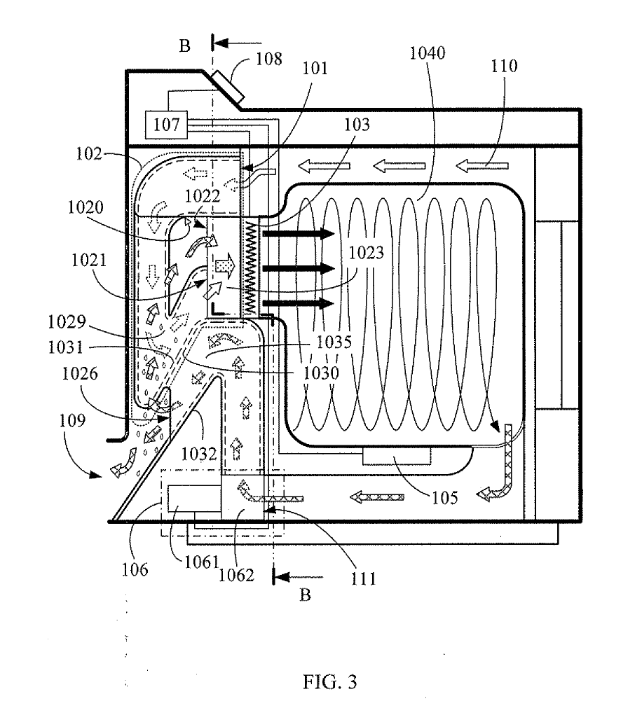

FIG. 3 is a schematic structural view showing the present invention being applied in a drum type cloth drying machine, according to one embodiment of the present invention;

The cross view of FIG. 3 taken along a B-B line is the same as FIG. 2;

As shown in FIG. 3 and FIG. 2, besides the housing, electric conductive wires and a drum device driven by an electric motor, it mainly consists of
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering a drum device (1040);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);

and having an top/down bended fluid pipeline (1035) formed by the external part of housing (1030) of the pipeline segment having water condensing function (1029) and an top/down bended flow guiding structure (1032) which allows the hot air discharged from the drum device (1040) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);

The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the drum device (1040) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;

through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing into the drum device (1040);
Drum device (1040): driven by a drum driving motor set (105) composed of a driving motor and a transmission device, for operation at the set rotation speed and rotating direction, and the drum device (1040) has a hot air inlet and outlet, the hot air inlet of the drum device (1040) allows the hot air from the fluid heating device (103) to flow in, the outlet of the drum device (1040) is provided for discharging the hot air which is leaded to the hot air pumping inlet (111) of the electric fluid pump (106), and the drum device (1040) is formed with a space inside for accommodating articles or cloth to be dried, and driven by the drum driving motor set (105) to rotate for uniformly receiving the drying provided by the hot air;
Drum driving motor set (105): constituted by an electric motor subjected to the operation of the electronic control device (107), and then via a transmission device to drive the drum device (1040) to rotate at the setting rotation speed and rotating direction;
Electric fluid pump (106): installed between the drum device (1040) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the drum device (1040) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the drum device (1040) after being re-heated by the fluid heating device (103);

A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103), the drum driving motor set (105) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);

When being operated, the electronic control device (107) actuates the electric fluid pump (106), the fluid heating device (103) and the drum driving motor set (105), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), then flows through the fluid heating device (103) for being heated then entering the drum device (1040), and the hot air containing water discharged from the drum device (1040) passes through the hot air pumping inlet (111), then is pumped by the electric fluid pump (106) to flow through the top/down bended fluid pipeline (1035);

The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior;

through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);

With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103), and when the hot air discharged from the drum device (1040) passes through the top/down bended fluid pipeline (1035), the thermal energy of the hot air is utilized to preheat the external air having relatively low temperature and passing through the internal part of housing (1031) of the pipeline segment having water condensing function (1029);

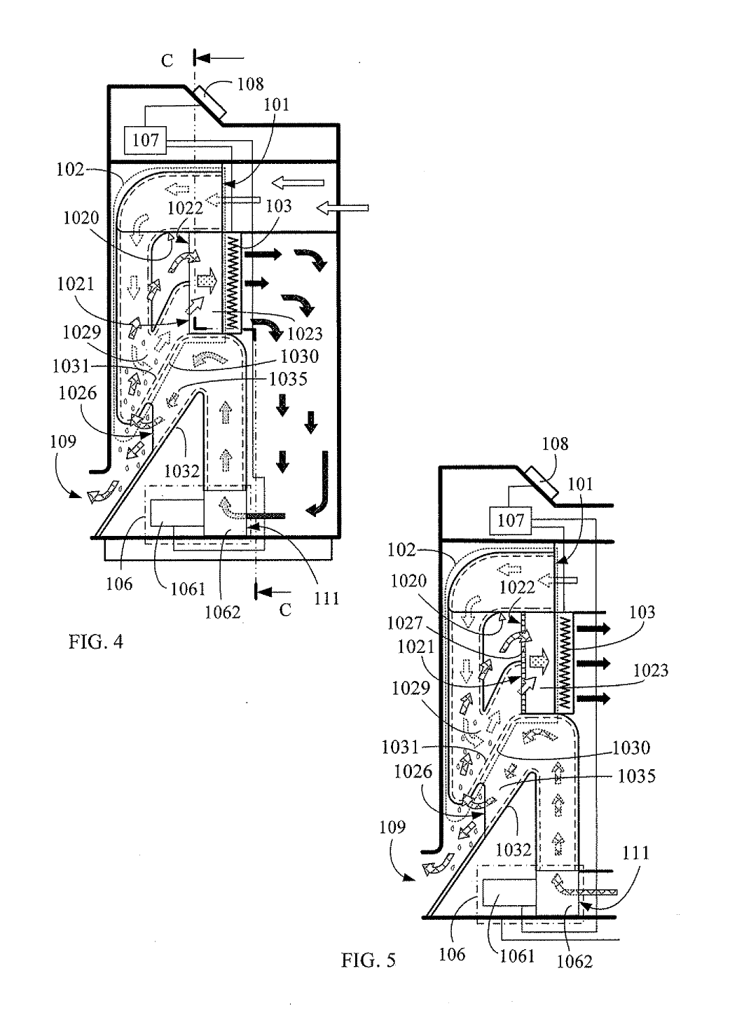

FIG. 4 is a schematic structural view showing the present invention being applied in a dehumidifier, according to one embodiment of the present invention;

The cross view of FIG. 4 taken along a C-C line is the same as FIG. 2;

As shown in FIG. 4 and FIG. 2, besides the housing and electric conductive wires, it mainly consists of
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering the hot air pumping inlet (111) to be pumped by the electric fluid pump (106) for passing through the top/down bended fluid pipeline (1035);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);

and having an top/down bended fluid pipeline (1035) formed by the external part of housing (1030) of the pipeline segment having water condensing function (1029) and an top/down bended flow guiding structure (1032) which allows the hot air discharged from the fluid heating device (103) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);

The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the fluid heating device (103) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;

through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing to the hot air pumping inlet (111);
Electric fluid pump (106): installed between the fluid heating device (103) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the fluid heating device (103) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the hot air pumping inlet (111) after being re-heated by the fluid heating device (103);

A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);

When being operated, the electronic control device (107) actuates the electric fluid pump (106) and the fluid heating device (103), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), and the hot air containing water discharged after being heated by the fluid heating device (103) is leaded to enter the hot air pumping inlet (111), then is pumped by the electric fluid pump (106) to flow through the top/down bended fluid pipeline (1035);

The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior for achieving the dehumidifying effect;

through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);

With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103) for being heated, and when the discharged hot air passes through the top/down bended fluid pipeline (1035), the thermal energy of the hot air is utilized to preheat the external air having relatively low temperature and passing through the internal part of housing (1031) of the pipeline segment having water condensing function (1029);

In the embodiments disclosed in FIG. 1, FIG. 2, FIG. 3 and FIG. 4, wherein between the cold/hot air mixing space structure (1023) and the fluid heating device (103), a labyrinth type flow mixing functional structure or multiple grid flow mixing functional structure or multiple partition board flow mixing functional structure can be further installed for unifying the preheated and mixed air;

FIG. 5 is a schematic structural view showing a static flow unifying structure (1027) being installed at the outlet of the cold/hot air mixing space structure (1023), according to one embodiment of the present invention;

As shown in FIG. 5, in the heat reflux drying machine utilizing inlet/outlet air temperature difference to condense water, the static flow unifying structure (1027) is installed between the cold/hot air mixing space structure (1023) and the fluid heating device (103), with the labyrinth type flow mixing functional structure or multiple grid flow mixing functional structure or multiple partition board flow mixing functional structure of the static flow unifying structure (1027), the preheated and mixed air can be unified for flowing to the fluid heating device (103) for being re-heated.

In the embodiments disclosed in FIG. 1, FIG. 2, FIG. 3 and FIG. 4, wherein between the cold/hot air mixing space structure (1023) and the fluid heating device (103), a free rotation stir blade structure (1028) can be further installed, thereby through the free rotation of the free rotation stir blade structure (1028), the preheated and mixed air is being stirred and unified;

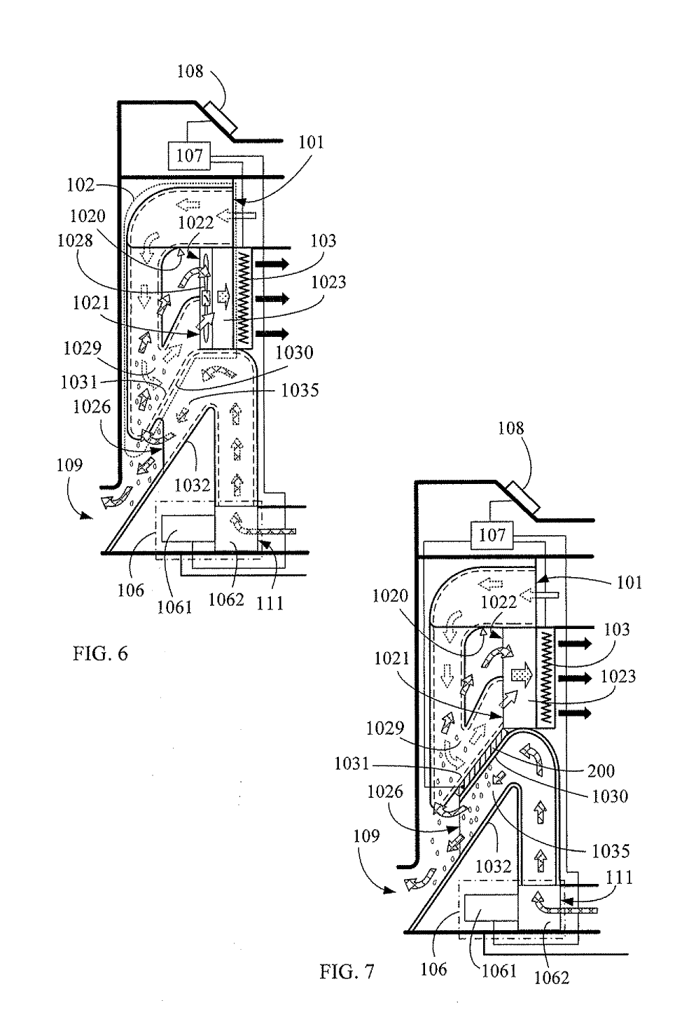

FIG. 6 is a schematic structural view showing a free rotation stir blade structure (1028) being installed at the outlet of the cold/hot air mixing space structure (1023), according to one embodiment of the present invention;

As shown in FIG. 6, in the heat reflux drying machine utilizing inlet/outlet air temperature difference to condense water of the present invention, the free rotation stir blade structure (1028) is installed between the cold/hot air mixing space structure (1023) and the fluid heating device (103), the free rotation of the free rotation stir blade structure (1028) can stir the preheated and mixed air for being unified then flowing to the fluid heating device (103) for being re-heated.

In the heat reflux drying machine utilizing inlet/outlet air temperature difference to condense water of the present invention, the static flow unifying structure (1027) and the free rotation stir blade structure (1028) can both be installed between the cold/hot air mixing space structure (1023) and the fluid heating device (103).

In the heat reflux drying machine utilizing inlet/outlet air temperature difference to condense water of the present invention, in order to increase the water condensing function to the water contained in the returned hot air passing the inlet/outlet temperature difference water condensing and heat refluxing device (102), a pipeline segment having water condensing function (1029) of the inlet/outlet temperature difference water condensing and heat refluxing device (102) can be further installed with an thermoelectric cooling chip (200) for increasing the water condensing effect to the hot air containing water passing through the external part of housing of the pipeline segment having water condensing function (1029), and for heating the external air in the internal part of housing of the pipeline segment having water condensing function (1029).

In the embodiments disclosed in FIG. 1, FIG. 2, FIG. 3 and FIG. 4, wherein an thermoelectric cooling chip (200) is further installed on the pipeline segment having water condensing function (1029), for increasing the water condensing effect to the hot air containing water passing through the external part of housing of the pipeline segment having water condensing function (1029), and for heating the external air in the internal part of housing of the pipeline segment having water condensing function (1029);

FIG. 7 is a schematic structural view showing the pipeline segment having water condensing function (1029) of the inlet/outlet temperature difference water condensing and heat refluxing device (102) being installed with the thermoelectric cooling chip (200), according to one embodiment of the present invention;

As shown in FIG. 7, the thermoelectric cooling chip (200) controlled by the electronic control device (107) is installed in the external part of housing of the pipeline segment having water condensing function (1029) or inside the pipeline, and the heating surface of the thermoelectric cooling chip (200) is provided for heating the internal part of housing of the pipeline segment having water condensing function (1029) allowing the external air to pass through, and the cooling surface of the thermoelectric cooling chip (200) is provided for cooling the external part of housing of the pipeline segment having water condensing function (1029) which allows the hot air containing water to pass through, so when the hot air containing water pumped by the electric fluid pump (106) passes through the pipeline segment having water condensing function (1029) combined to the cooling surface of the thermoelectric cooling chip (200), the water condensing effect is increased, meanwhile the external air passing through the pipeline segment having water condensing function (1029) combined to the heating surface of the thermoelectric cooling chip (200) is heated.

Moreover, it further includes that the fluid heating device (103) is not provided in the embodiments of the heat reflux drying machine utilizing inlet/outlet air temperature difference to condense water disclosed of the present invention in FIG. 1, FIG. 2, FIG. 3 and FIG. 4, and replaced by the thermoelectric cooling chip (200) disposed in the pipeline segment having water condensing function (1029), for increasing the water condensing effect to the hot air containing water passing through the external part of housing of the pipeline segment having water condensing function (1029), and for heating the external air in the internal part of housing of the pipeline segment having water condensing function (1029).

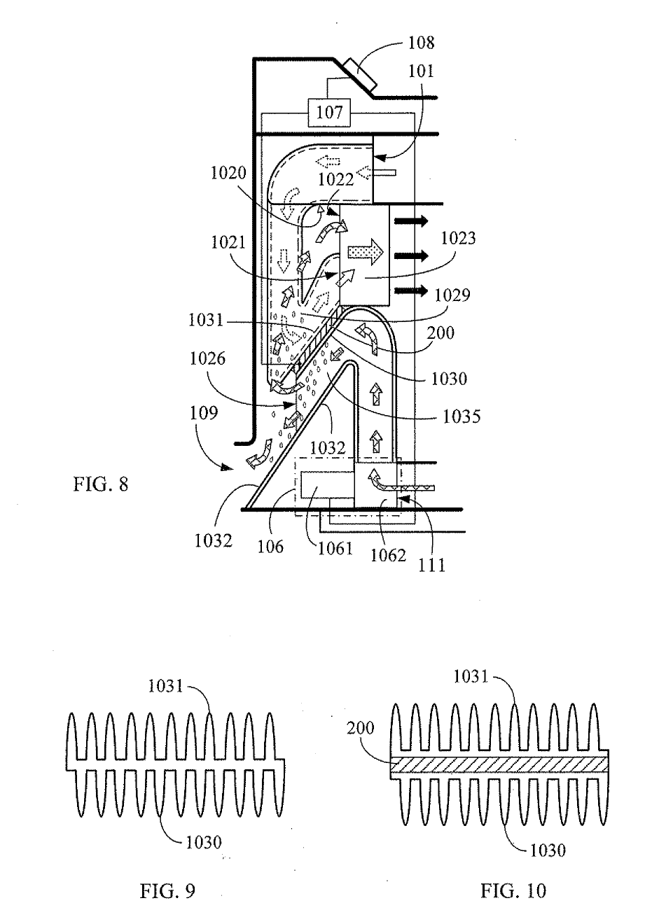

FIG. 8 is a schematic structural view showing the pipeline segment having water condensing function (1029) of the inlet/outlet temperature difference water condensing and heat refluxing device (102) being installed with the thermoelectric cooling chip (200) for replacing the fluid heating device (103), according to one embodiment of the present invention;

As shown in FIG. 8, the thermoelectric cooling chip (200) controlled by the electronic control device (107) is installed in the external part of housing of the pipeline segment having water condensing function (1029) or inside the pipeline, the heating surface of the thermoelectric cooling chip (200) is provided for heating the internal part of housing of the pipeline segment having water condensing function (1029) allowing the external air to pass through, and the cooling surface of the thermoelectric cooling chip (200) is provided for cooling the external part of housing of the pipeline segment having water condensing function (1029) which allows the hot air containing water to pass through, so when the hot air containing water pumped by the electric fluid pump (106) passes through the pipeline segment having water condensing function (1029) combined to the cooling surface of the thermoelectric cooling chip (200), the water condensing effect is increased, meanwhile the external air passing through the pipeline segment having water condensing function (1029) combined to the heating surface of the thermoelectric cooling chip (200) is heated, thereby the function of the fluid heating device (103) being replaced and no fluid heating device (103) being installed.

FIG. 8 shows the heat reflux drying machine utilizing inlet/outlet air temperature difference to condense water is installed with the thermoelectric cooling chip (200) and not provided with the fluid heating device (103), wherein a labyrinth type flow mixing functional structure or multiple grid flow mixing functional structure or multiple partition board flow mixing functional structure can be further installed to the cold/hot air mixing space structure (1023) for unifying the preheated mixed air; or a free rotation stir blade structure (1028) can be further installed to the cold/hot air mixing space structure (1023), so the free rotation of the free rotation stir blade structure (1028) can stir the preheated and mixed air for being unified; or the above two are both installed;

According to the heat reflux drying machine utilizing inlet/outlet air temperature difference to condense water of the present invention, in the pipeline segment having water condensing function (1029) of the inlet/outlet temperature difference water condensing and heat refluxing device (102), the contact surface in the internal part of housing of the pipeline segment having water condensing function (1029) which allows the external air to pass through, and the contact surface at the external part of housing of the pipeline segment having water condensing function (1029) which allows the hot air containing water pumped by the electric fluid pump (106) to pass through are further formed in fin-like shapes for increasing the water condensing function.

FIG. 9 is a cross view showing the internal and external parts of the pipeline segment having water condensing function (1029) being formed in fin-like shapes, according to one embodiment of the present invention.

As shown in FIG. 9, in the pipeline segment having water condensing function (1029) of the inlet/outlet temperature difference water condensing and heat refluxing device (102), the contact surface in the internal part of housing of the pipeline segment having water condensing function (1029) which allows the external air to pass through, and the contact surface in the external part of housing of the pipeline segment having water condensing function (1029) which allows the hot air containing water pumped by the electric fluid pump (106) to pass through are formed in fin-like shapes for increasing the water condensing function.

FIG. 10 is a cross view showing the internal and external parts of the pipeline segment having water condensing function (1029) being installed with the thermoelectric cooling chip (200), according to one embodiment of the present invention.

As shown in FIG. 10, the pipeline segment having water condensing function (1029) of the inlet/outlet temperature difference water condensing and heat refluxing device (102) is further installed with the thermoelectric cooling chip (200), and the contact surface in the internal part of housing of the pipeline segment having water condensing function (1029) which allows the external air to pass through, and the contact surface at the external part of housing of the pipeline segment having water condensing function (1029) which allows the hot air containing water pumped by the electric fluid pump (106) to pass through are formed in fin-like shapes for increasing the water condensing function.

1. A heat reflux drying machine utilizing inlet/outlet air temperature difference to condense water, applied to various kinds of drying machines, wherein an electric fluid pump is installed for pumping external air having relatively low temperature into a fluid heating device for being heated then entering a heating space for drying the articles to be dried, and further installed with an inlet/outlet temperature difference water condensing and heat refluxing device (102), wherein the external air having relatively low temperature is pumped by the electric fluid pump (106) for entering an internal part of housing (1031) of a pipeline segment having water condensing function (1029), then entering a cold/hot air mixing space structure (1023) from an air intake port (1021), meanwhile the hot air containing water discharged from the heating space passes through the hot air pumping inlet (111) then be pumped by the electric fluid pump (106) for passing through a top/down bended fluid pipeline (1035) formed by an external part of housing (1030) of the pipeline segment having water condensing function (1029) and a top/down bended flow guiding structure (1032), then a part of the hot air passes through a hot air shunt port (1026) and a fluid guiding surface (1020) for entering the cold/hot air mixing space structure (1023) for being preheated and mixed with the pumped-in external air having relatively low temperature then entering a fluid heating device (103) for the subsequent heating, thereby reducing thermal energy loss and saving electric energy. With the hot air shunt port (1026), a part of the hot air is discharged from an external discharging port (109), meanwhile the thermal energy of the hot air passing through the top/down bended fluid pipeline (1035) formed by the external part of housing (1030) of the pipeline segment having water condensing function (1029) and the top/down bended flow guiding structure (1032) is utilized to preheat the external air having relative low temperature passing through the internal part of housing (1031) of the pipeline segment having water condensing function (1029), thus the temperature difference of the above two enables the water contained in the hot air to be condensed in the external part of housing (1030) of the pipeline segment having water condensing function (1029) of the inlet/outlet temperature difference water condensing and heat refluxing device (102) for being collected or discharged to the exterior; it mainly consists of:
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering a heating space (104);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);
and having an top/down bended fluid pipeline (1035) formed by the external part of housing (1030) of the pipeline segment having water condensing function (1029) and an top/down bended flow guiding structure (1032) which allows the hot air discharged from the heating space (104) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);
The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the heating space (104) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;
through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing into the heating space (104);
Heating space (104): having a hot air inlet and outlet, formed with an internal space for accommodating the articles to be dried, wherein the heating space can be a sealed space, semi-opened space or opened space; the hot air inlet of the heating space (104) allows the hot air from the fluid heating device (103) to flow in, and the hot air outlet of the heating space (104) is provided for discharging the hot air which is leaded to the hot air pumping inlet (111);
Electric fluid pump (106): installed between the heating space (104) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the heating space (104) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the heating space (104) after being re-heated by the fluid heating device (103);
A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);
When being operated, the electronic control device (107) actuates the electric fluid pump (106) and the fluid heating device (103), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), then flows through the fluid heating device (103) for being heated then entering the heating space (104), and the hot air containing water discharged from the heating space (104) passes through the hot air pumping inlet (111), then is pumped by the electric fluid pump (106) to flow through the top/down bended fluid pipeline (1035);
The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior;
through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);
With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103), and when the hot air discharged from the heating space (104) passes through the top/down bended fluid pipeline (1035), the thermal energy of the hot air is utilized to preheat the external air having relatively low temperature and passing through the internal part of housing (1031) of the pipeline segment having water condensing function (1029).

2. A heat reflux drying machine utilizing inlet/outlet air temperature difference to condense water as claimed in claim 1, wherein it includes to be applied in a drum type cloth drying machine, and besides the housing, electric conductive wires and a drum device driven by an electric motor, it mainly consists of:
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering a drum device (1040);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);
and having an top/down bended fluid pipeline (1035) formed by the external part of housing (1030) of the pipeline segment having water condensing function (1029) and an top/down bended flow guiding structure (1032) which allows the hot air discharged from the drum device (1040) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);
The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the drum device (1040) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;
through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing into the drum device (1040);
Drum device (1040): driven by a drum driving motor set (105) composed of a driving motor and a transmission device, for operation at the set rotation speed and rotating direction, and the drum device (1040) has a hot air inlet and outlet, the hot air inlet of the drum device (1040) allows the hot air from the fluid heating device (103) to flow in, the outlet of the drum device (1040) is provided for discharging the hot air which is leaded to the hot air pumping inlet (111) of the electric fluid pump (106), and the drum device (1040) is formed with a space inside for accommodating articles or cloth to be dried, and driven by the drum driving motor set (105) to rotate for uniformly receiving the drying provided by the hot air;
Drum driving motor set (105): constituted by an electric motor subjected to the operation of the electronic control device (107), and then via a transmission device to drive the drum device (1040) to rotate at the setting rotation speed and rotating direction;
Electric fluid pump (106): installed between the drum device (1040) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the drum device (1040) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the drum device (1040) after being re-heated by the fluid heating device (103);
A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103), the drum driving motor set (105) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);
When being operated, the electronic control device (107) actuates the electric fluid pump (106), the fluid heating device (103) and the drum driving motor set (105), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), then flows through the fluid heating device (103) for being heated then entering the drum device (1040), and the hot air containing water discharged from the drum device (1040) passes through the hot air pumping inlet (111), then is pumped by the electric fluid pump (106) to flow through the top/down bended fluid pipeline (1035);
The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior;
through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);
With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103), and when the hot air discharged from the drum device (1040) passes through the top/down bended fluid pipeline (1035), the thermal energy of the hot air is utilized to preheat the external air having relatively low temperature and passing through the internal part of housing (1031) of the pipeline segment having water condensing function (1029).

3. A heat reflux drying machine utilizing inlet/outlet air temperature difference to condense water as claimed in claim 1, wherein it includes being applied in a dehumidifier, and besides the housing and electric conductive wires, it mainly consists of:
Air inlet (101): the external air having relatively low temperature is pumped by an electric fluid pump (106) for being introduced from the air inlet (101) to an air intake flowpath (110), and the external air passes through an internal part of housing (1031) of a pipeline segment having water condensing function (1029) and a cold/hot air mixing space structure (1023), then passes through a fluid heating device (103) for being heated then entering the hot air pumping inlet (111) to be pumped by the electric fluid pump (106) for passing through the top/down bended fluid pipeline (1035);
Inlet/outlet temperature difference water condensing and heat refluxing device (102): having a connection port structure connected with the air intake flowpath (110), so the external air having relatively low temperature pumped in from the air inlet (101) connected to the air intake flowpath (110) is allowed to pass through the internal part of housing (1031) of the pipeline segment having water condensing function (1029) then enters the cold/hot air mixing space structure (1023) through the air intake port (1021);
and having an top/down bended fluid pipeline (1035) formed by the external part of housing (1030) of the pipeline segment having water condensing function (1029) and an top/down bended flow guiding structure (1032) which allows the hot air discharged from the fluid heating device (103) to pass through; and having a hot air shunt port (1026) and a fluid guiding surface (1020), with the structure of the hot air shunt port (1026) and the fluid guiding surface (1020), a part of the hot air passing through the top/down bended fluid pipeline (1035) is guided by the fluid guiding surface (1020) to enter the cold/hot air mixing space structure (1023) through a returned hot air inlet (1022), so as to be preheated and mixed with the external air having relatively low temperature in the cold/hot air mixing space structure (1023) then entering the fluid heating device (103) for the subsequent heating, meanwhile the thermal energy of the hot air flowing towards the top/down bended fluid pipeline (1035) is utilized to preheat the external air having relatively low temperature passing through the internal part of housing (1031) of the pipeline segment having water condensing function (1029);
The external part of housing (1030) of the pipeline segment having water condensing function (1029) provides a water condensing function, with the external air having relatively low temperature passing through the internal part of housing (1031) of the pipeline segment having water condensing function (1029), and the hot air containing water discharged from the fluid heating device (103) being pumped by the electric fluid pump (106) while entering from the hot air pumping inlet (111) to pass through the top/down bended fluid pipeline (1035), the temperature difference of the above two enables the water contained in the hot air passing through the top/down bended fluid pipeline (1035) to be condensed in the external part of housing (1030) of the pipeline segment having water condensing function (1029) for being collected or discharged to the exterior;
through the shunting of the hot air shunt port (1026), a part of the hot air is discharged to the exterior from the external discharging port (109);
Fluid heating device (103): constituted by an electric heating device which utilizes electric energy to generate heat, controlled by an electronic control device (107) for controlling the heating temperature and operation of ON/OFF, and provided for re-heating the preheated and mixed air from the cold/hot air mixing space structure (1023) then flowing to the hot air pumping inlet (111);
Electric fluid pump (106): installed between the fluid heating device (103) and the top/down bended fluid pipeline (1035), wherein a fluid pumping motor (1061) is electrically charged to operate for driving a fluid pump (1062) to pump the external air having relatively low temperature to pass through the air intake flowpath (110) and the internal part of housing (1031) of the pipeline segment having water condensing function (1029), then enters the cold/hot air mixing space structure (1023) through the air intake port (1021), meanwhile the hot air discharged from the fluid heating device (103) is pumped by the electric fluid pump (106) to flow towards the hot air pumping inlet (111), then flow to the top/down bended fluid pipeline (1035) then flow pass the hot air shunt port (1026) for being shunted, so that a part of the hot air is guided by the fluid guiding surface (1020) to flow back to the cold/hot air mixing space structure (1023) through the returned hot air inlet (1022), for being preheated and mixed with the external air having relatively low temperature passing through the air inlet (101) and the air intake flowpath (110) and the internal part of housing (1031) of the pipeline segment having water condensing function (1029) before entering the fluid heating device (103), and flowing into the hot air pumping inlet (111) after being re-heated by the fluid heating device (103);
A part of the mentioned hot air passing through the top/down bended fluid pipeline (1035) is shunted by the hot air shunt port (1026) for being discharged to the exterior through the external discharging port (109);
Electronic control device (107): constituted by the electromechanical unit or solid state electronic circuit unit and/or micro processer and operation software, for receiving the electric power from a power source and receiving the settings and operations of an external operation interface (108), so as to control the operations of the fluid heating device (103) and the electric fluid pump (106);
External operation interface (108): constituted by the electromechanical unit or solid state electronic circuit unit and/or micro processer and operation software, for receiving manual inputs to control the electronic control device (107);
External discharging port (109): allowing the hot air passing through the top/down bended fluid pipeline (1035) of the inlet/outlet temperature difference water condensing and heat refluxing device (102) to be guided by the hot air shunt port (1026) and a part of the hot air is discharged to the exterior from the external discharging port (109);
When being operated, the electronic control device (107) actuates the electric fluid pump (106) and the fluid heating device (103), and at this moment, the external air having relatively low temperature enters the internal part of housing (1031) of the pipeline segment having water condensing function (1029) through the air inlet (101), and passes through the air intake port (1021) for entering the cold/hot air mixing space structure (1023), and the hot air containing water discharged after being heated by the fluid heating device (103) is leaded to enter the hot air pumping inlet (111), then is pumped by the electric fluid pump (106) to flow through the top/down bended fluid pipeline (1035);
The external part of housing (1030) of the pipeline segment having water condensing function (1029) of the inlet/outlet temperature difference water condensing and heat refluxing device (102) provides the water condensing function, and the temperature difference between the external air having relatively low temperature passing through the internal part of housing (1031) of the pipeline segment having water condensing function (1029) and the hot air passing through the top/down bended fluid pipeline (1035) allows the water contained in the hot air to be condensed in the external part of housing (1030) of the pipeline segment having water condensing function (1029) for being collected or discharged to the exterior for achieving the dehumidifying effect;
through the shunting of the hot air shunt port (1026), a part of the hot air passing through the external part of housing (1030) of the pipeline segment having water condensing part (1029) is shunted by the hot air shunt port (1026) for being discharged to the exterior from the external discharging port (109);
With the structure of the hot air shunt port (1026) and the fluid guiding surface (1020), a part of the hot air is guided by the returned hot air inlet (1022) for entering the cold/hot air mixing space structure (1023) and being preheated and mixed with the external air having relatively low temperature in the cold/hot air mixing space structure (1023) then entering the fluid heating device (103) for being heated, and when the discharged hot air passes through the top/down bended fluid pipeline (1035), the thermal energy of the hot air is utilized to preheat the external air having relatively low temperature and passing through the internal part of housing (1031) of the pipeline segment having water condensing function (1029).

4. A heat reflux drying machine utilizing inlet/outlet air temperature difference to condense water as claimed in claims 1˜3, wherein a labyrinth type flow mixing functional structure or multiple grid flow mixing functional structure or multiple partition board flow mixing functional structure can be further installed for unifying the preheated and mixed air; the static flow unifying structure (1027) is installed between the cold/hot air mixing space structure (1023) and the fluid heating device (103), with the labyrinth type flow mixing functional structure or multiple grid flow mixing functional structure or multiple partition board flow mixing functional structure of the static flow unifying structure (1027), the preheated and mixed air can be unified for flowing to the fluid heating device (103) for being re-heated.

5. A heat reflux drying machine utilizing inlet/outlet air temperature difference to condense water as claimed in claims 1˜3, wherein a free rotation stir blade structure (1028) can be further installed, thereby through the free rotation of the free rotation stir blade structure (1028), the preheated and mixed air is being stirred and unified; the free rotation stir blade structure (1028) is installed between the cold/hot air mixing space structure (1023) and the fluid heating device (103), the free rotation of the free rotation stir blade structure (1028) can stir the preheated and mixed air for being unified then flowing to the fluid heating device (103) for being re-heated.

6. A heat reflux drying machine utilizing inlet/outlet air temperature difference to condense water as claimed in claims 1˜3, wherein the static flow unifying structure (1027) and the free rotation stir blade structure (1028) can both be installed between the cold/hot air mixing space structure (1023) and the fluid heating device (103).

7. A heat reflux drying machine utilizing inlet/outlet air temperature difference to condense water as claimed in claims 1˜3, wherein an thermoelectric cooling chip (200) is further installed on the pipeline segment having water condensing function (1029), for increasing the water condensing effect to the hot air containing water passing through the external part of housing of the pipeline segment having water condensing function (1029), and for heating the external air in the internal part of housing of the pipeline segment having water condensing function (1029); the thermoelectric cooling chip (200) controlled by the electronic control device (107) is installed in the external part of housing of the pipeline segment having water condensing function (1029) or inside the pipeline, and the heating surface of the thermoelectric cooling chip (200) is provided for heating the internal part of housing of the pipeline segment having water condensing function (1029) allowing the external air to pass through, and the cooling surface of the thermoelectric cooling chip (200) is provided for cooling the external part of housing of the pipeline segment having water condensing function (1029) which allows the hot air containing water to pass through, so when the hot air containing water pumped by the electric fluid pump (106) passes through the pipeline segment having water condensing function (1029) combined to the cooling surface of the thermoelectric cooling chip (200), the water condensing effect is increased, meanwhile the external air passing through the pipeline segment having water condensing function (1029) combined to the heating surface of the thermoelectric cooling chip (200) is heated.

8. A heat reflux drying machine utilizing inlet/outlet air temperature difference to condense water as claimed in claims 1˜3, wherein the fluid heating device (103) is not provided, which is replaced by the thermoelectric cooling chip (200) disposed in the pipeline segment having water condensing function (1029), for increasing the water condensing effect to the hot air containing water passing through the external part of housing of the pipeline segment having water condensing function (1029), and for heating the external air in the internal part of housing of the pipeline segment having water condensing function (1029); the thermoelectric cooling chip (200) controlled by the electronic control device (107) is installed in the external part of housing of the pipeline segment having water condensing function (1029) or inside the pipeline, the heating surface of the thermoelectric cooling chip (200) is provided for heating the internal part of housing of the pipeline segment having water condensing function (1029) allowing the external air to pass through, and the cooling surface of the thermoelectric cooling chip (200) is provided for cooling the external part of housing of the pipeline segment having water condensing function (1029) which allows the hot air containing water to pass through, so when the hot air containing water pumped by the electric fluid pump (106) passes through the pipeline segment having water condensing function (1029) combined to the cooling surface of the thermoelectric cooling chip (200), the water condensing effect is increased, meanwhile the external air passing through the pipeline segment having water condensing function (1029) combined to the heating surface of the thermoelectric cooling chip (200) is heated, thereby the function of the fluid heating device (103) being replaced and no fluid heating device (103) being installed.

9. A heat reflux drying machine utilizing inlet/outlet air temperature difference to condense water as claimed in claims 1, 2, 3, wherein in the pipeline segment having water condensing function (1029) of the inlet/outlet temperature difference water condensing and heat refluxing device (102), the contact surface in the internal part of housing of the pipeline segment having water condensing function (1029) which allows the external air to pass through, and the contact surface in the external part of housing of the pipeline segment having water condensing function (1029) which allows the hot air containing water pumped by the electric fluid pump (106) to pass through are formed in fin-like shapes for increasing the water condensing function.

10. A heat reflux drying machine utilizing inlet/outlet air temperature difference to condense water as claimed in claim 8, wherein in the pipeline segment having water condensing function (1029) of the inlet/outlet temperature difference water condensing and heat refluxing device (102), the contact surface in the internal part of housing of the pipeline segment having water condensing function (1029) which allows the external air to pass through, and the contact surface in the external part of housing of the pipeline segment having water condensing function (1029) which allows the hot air containing water pumped by the electric fluid pump (106) to pass through are formed in fin-like shapes for increasing the water condensing function.

11. A heat reflux drying machine utilizing inlet/outlet air temperature difference to condense water as claimed in claims 1, 2, 3, wherein the pipeline segment having water condensing function (1029) of the inlet/outlet temperature difference water condensing and heat refluxing device (102) is further installed with the thermoelectric cooling chip (200), and the contact surface in the internal part of housing of the pipeline segment having water condensing function (1029) which allows the external air to pass through, and the contact surface at the external part of housing of the pipeline segment having water condensing function (1029) which allows the hot air containing water pumped by the electric fluid pump (106) to pass through are formed in fin-like shapes for increasing the water condensing function.

12. A heat reflux drying machine utilizing inlet/outlet air temperature difference to condense water as claimed in claim 8, wherein the pipeline segment having water condensing function (1029) of the inlet/outlet temperature difference water condensing and heat refluxing device (102) is further installed with the thermoelectric cooling chip (200), and the contact surface in the internal part of housing of the pipeline segment having water condensing function (1029) which allows the external air to pass through, and the contact surface at the external part of housing of the pipeline segment having water condensing function (1029) which allows the hot air containing water pumped by the electric fluid pump (106) to pass through are formed in fin-like shapes for increasing the water condensing function.

13. A heat reflux drying machine utilizing inlet/outlet air temperature difference to condense water as claimed in claim 8, wherein a labyrinth type flow mixing functional structure or multiple grid flow mixing functional structure or multiple partition board flow mixing functional structure can be further installed for unifying the preheated and mixed air; the static flow unifying structure (1027) is installed between the cold/hot air mixing space structure (1023) and the fluid heating device (103), with the labyrinth type flow mixing functional structure or multiple grid flow mixing functional structure or multiple partition board flow mixing functional structure of the static flow unifying structure (1027), the preheated and mixed air can be unified for flowing to the fluid heating device (103) for being re-heated.

14. A heat reflux drying machine utilizing inlet/outlet air temperature difference to condense water as claimed in claim 8, wherein a free rotation stir blade structure (1028) can be further installed, thereby through the free rotation of the free rotation stir blade structure (1028), the preheated and mixed air is being stirred and unified; the free rotation stir blade structure (1028) is installed between the cold/hot air mixing space structure (1023) and the fluid heating device (103), the free rotation of the free rotation stir blade structure (1028) can stir the preheated and mixed air for being unified then flowing to the fluid heating device (103) for being re-heated.

15. A heat reflux drying machine utilizing inlet/outlet air temperature difference to condense water as claimed in claim 8, wherein the static flow unifying structure (1027) and the free rotation stir blade structure (1028) can both be installed between the cold/hot air mixing space structure (1023) and the fluid heating device (103).
